(19) United States
(12) Patent Application Publication
(10) Pub. No.: US 2014/0270406 A1
(43) Pub. Date: Sep. 18, 2014

(54) Suja's Aesthetic Grading SAG - check pattern

(71) Applicant: Suja Ani George, Thiruvananthapuram (IN)

(72) Inventor: Suja Ani George, Thiruvananthapuram (IN)

(21) Appl. No.: 13/726,790

(22) Filed: Mar. 17, 2013

(51) Int. Cl. G06K 9/00

(52) U.S. Cl. CPC G06K 9/00221
USPC 382/118

(57) ABSTRACT

Techniques have been developed to measure and/or quantify beauty for facial aesthetic grading and for ‘Biometrics in facial aesthetics’. The ‘check pattern for aesthetic grading’ may be considered as another milestone towards an ideal proportion for facial aesthetics; this is a proof for the fact that in their respective spheres—space to matter and matter to space—all is adjusted in number, weight and measure.

### CROSS-REFERENCE TO RELATED APPLICATIONS

Not Applicable

### STATEMENT REGARDING FEDERALLY SPONSORED RESEARCH OR DEVELOPMENT

Not Applicable

REFERENCE TO SEQUENCE LISTING, A TABLE, OR A COMPUTER PROGRAM LISTING COMPACT

Not Applicable

### DISC APPENDIX

Not Applicable

### BACKGROUND OF THE INVENTION

This is one of the new contributions made through the first doctorate (PhD) in orthodontics in India, PhD awarded in 2010. Invention pertains to the field of Dentistry; Methods to measure facial AESTHETICS from standardized facial photographs and cephalograms and anthropometric measurements are developed.

I could not find any references to specific documents which are related to my invention.

The specific problem involved in the prior art (or state of technology) on which this invention is drawn was that facial aesthetics could not be measured. Beauty lies in the eyes of the beholder—goes the saying. But now, beauty can be quantified.

### BRIEF SUMMARY OF THE INVENTION

Invention is described under the following headings: ‘check pattern on frontal view facial photographs’ for Beauty Index, and Symmetry; ‘check pattern on profile view facial photographs’ for Z index; ‘check pattern on frontal and profile view facial photographs’ for Indices, ‘check pattern on cephalograms’ and ‘Check pattern on anthropometric measurements’. Quantification of facial beauty is successfully attempted. Reproducible measurements are made possible; ‘Biometrics in facial aesthetics’ is also made possible.

The advantages of the invention are: Beauty can be quantified; facial beauty is made a quantitative reproducible measurement by the ‘check pattern’ for aesthetic grading, on photographs, cephalograms and anthropometric measurements.

The previously existing problem was that facial beauty could not be quantified. ‘Beauty lies in the eyes of the beholder’ was the saying, and assessment of beauty was a qualitative/subjective measure. There is a difference in perception by different categories of evaluators; and perception is multifactorial. The modes of judgments also affect the judgements in facial aesthetics.

So, now, methods to quantify beauty are developed, instead of using the instrument of perception. Now it can be measured or quantified. Measurements include measurements on frontal view facial photographs, on profile view facial photographs, on cephalograms and anthropometric measurements. Reproducible measures are obtained. The ‘check pattern’ for aesthetic grading may be considered as another milestone towards an ideal proportion for facial aesthetics; this is a proof for the fact that in their respective spheres—space to matter and matter to space—all is adjusted in number, weight and measure.

The objective of the invention was quantification of facial beauty, i.e., facial aesthetics. Proportions of linear, angular and area measurements towards an ideal proportion (‘check pattern’ for facial photographs and cephalograms and anthropometric measurements) are reproducible measurements.

An aesthetic grading based on Cephalic Index alone is also made possible. This is useful in facial reconstruction surgical procedures.

Steps in aesthetic grading: Obtain the frontal and profile view facial photographs, and cephalogram, all taken in a standardised manner and also obtain the Anthropometric measurements (height and weight and BMI, and the cephalic measurements).

For photometric analysis, the facial photographs taken in a standardised manner are scanned in the Bitmap (BMP) format to reduce compression. The drawings and the measurements needed for the Check pattern are made using the ImageJ (with reference to software link—http://rsb.info.nih.gov/ij/) (and ImageJ plugin). Marks for Beauty index and Symmetry Index are the outputs. Marks for Z index are obtained using the ‘Z calculator’ on making the necessary entries in the calculator. For check pattern on facial indices, first take measurements using ImageJ and compute the ratios using the index calculator. Locate the name of the parameter for facial indices from the tables available (see reference to the doctoral work in paragraph 0043). Enter the values (mean, SD/SE, and the sample number) available in the tables in the respective columns of the ‘Percentage and Range calculator’. Marks are obtained as the output. Sum up the marks for each candidate. Find out the top scorers.

The cephalograms are manually traced, scanned in the Bitmap (BMP) format to reduce compression. Lines are drawn and measurements are taken using ImageJ. Compute marks using the ‘Percentage and Range calculator’. Locate the name of the parameter from the tables available (see reference to the doctoral work in paragraph 0043). Enter the values (mean, SD/SE, and the sample number) available in the tables in the respective columns of the calculator. From the output, find out the marks of the candidate.

Tables are available (see reference to the doctoral work in paragraph 0043) for aesthetic grading based on the cephalic index. This is especially useful in surgical cases, in trauma, facial anomalies etc, where facial reconstruction is needed. Aesthetic facial measurements needed for the candidate under consideration, based on the cephalic type, are computed using the calculator.

Anthropometric measurements: Anthropometric measurements needed in the aesthetic grading of the candidate are made. The height and weight measurements are used to compute the BMI and the Weight/Height ratio of the candidate, to be used in Check pattern on frontal view photographs. Data on Anthropometric measurements are available (see reference to the doctoral work in paragraph 0043).

Software programs used: Measurements are made using ImageJ. The software programs used are: ImageJ (and ImageJ plugin) and the symmetry calculator (for the Beauty index and for symmetry index), the ‘Z calculator’ (For Z index), the ‘Percentage and Range calculator’ and ‘index calculator’ (for the facial indices and for aesthetic grading on the cephalograms) and ‘index calculator’ (for Anthropometric measurements).

Sum up the marks from the different steps mentioned above to find out the top scorers.

### BRIEF DESCRIPTION OF THE SEVERAL VIEWS OF THE DRAWING

List of figures

FIG. 1: The Figure obtained by drawing lines on the frontal view that divided the frontal view into 20 rectangles.

FIG. 2: Rectangles taken up for analysis (drawn in red)

FIG. 3: Rectangle relating to the central nose area

FIG. 4: Proportions of areas towards an ideal proportion

FIG. 5: Photograph of the candidate, showing the codes of landmarks used in photometric analysis; Tr′ is the code of the landmark Trichion

FIG. 6: An illustration of the symmetry calculator

FIG. 7: Figure for symmetry analysis

FIG. 8: An illustration of the z calculator

FIG. 9: Parameters for calculator file on ‘Z index’—an illustration of total mark calculation for a candidate with ideal values

FIG. 10: The ‘z’ angles

FIG. 11: Triangle OE1E2 drawn on relevant portion of FIG. 10

FIG. 12: E1-T1-T2

FIG. 13: C1-c-N′ and e-C1-n′

FIG. 14: I′-Tr-Tn and Tn-Me′-Tr

FIG. 15: Tn-Me′-Tr

FIG. 16: fgg′, fg1g2, fg3g4

FIG. 17: relevant portion of Fig CP 16 enlarged

FIG. 18: Angles around ‘f’

FIG. 19: h-Me′-Tr

FIG. 20: p-Tn-Me′

FIG. 21: intersection of lines N′ Tr, I′-Me′ and Sto-Tr to give a golden triangle

FIG. 22: Index calculator—an illustration

FIG. 23: ‘Percentage and Range calculator’—a section from an illustration

FIG. 24: A figure from Biometrics of the eye in ‘Biometrics in facial aesthetics’

FIG. 25: A figure from Biometrics of the eye in ‘Biometrics in facial aesthetics’

FIG. 26: A figure from ‘Biometrics in facial aesthetics’

FIG. 27: Another figure from ‘Biometrics in facial aesthetics’

### DETAILED DESCRIPTION OF THE INVENTION

The invention is described under the following main headings, ‘check pattern on frontal view photographs’ for Beauty Index, and Symmetry Index; ‘check pattern on profile view photographs’ for Z index; ‘check pattern on frontal and profile view photographs’ for Indices, and ‘check pattern on cephalograms’ and ‘Check pattern on anthropometric measurements’.

‘CHECK PATTERN ON FRONTAL VIEW PHOTOGRAPHS’ FOR BEAUTY INDEX: Procedure: The Height, Weight and the Body Mass Index (BMI) of the candidate are found out; and Measurements on frontal view photograph are made using the imageJ plugin. Beauty index comes as the output.

Body Mass Index (BMI) and Photometric Measurements: To relate Body Mass Index (BMI) and Photometric Measurements, the following procedure was done: The following lines were drawn on the frontal view photograph. a. Inter-pupillary line (line 1, FIG. 1); b. a line through ala (base, at maximum width) of the nose, parallel to the inter-pupillary line (line 2, FIG. 1); c. A line through stomion, parallel to the inter-pupillary line (line 3, FIG. 1); d. A line through chin, parallel to the inter-pupillary line (line 4, FIG. 1); e. Hair line—a line through Tr′, parallel to the inter-pupillary line (line 5, FIG. 1); (Tr′ is Trichion, a photometric landmark used in the photometric analysis—see the footnote in section 0027). Also shown in the figure (FIG. 1) are lines drawn through inner and outer canthi of the eyes and through the outer most ear lobe region, perpendicular to the inter-pupillary line.

The Figure obtained by drawing these lines on the frontal view divided the frontal view into 20 rectangles; it is shown in FIG. 1.

Out of these 20 rectangles, 9 rectangles located in the facial region, centrally, relating to the nasal and the lip areas were taken up for the following analysis.

FIG. 2 shows the rectangles (drawn in red) taken up for analysis. The areas of the rectangles were calculated. The rectangular areas divided by 1. Body Mass Index (BMI) of the candidate; 2. (Weight/Height) ratio of the candidate; 3. The area of the smallest rectangle of the 9 rectangles and 4. The area of the rectangle relating to the central nose area. Rectangle relating to the central nose area is shown in FIG. 3. Proportions of areas towards an ideal proportion are shown in the table in FIG. 4.

Inference: it is observed that the central rectangle is related to others.

Proportions of areas towards an ideal proportion (‘check pattern for photographs’): numbers in the Fibonacci series are taken up as the preferred numbers in the area deciding numbers of the ideal rectangles. See the table shown in FIG. 4.

The values in the above rectangle, named as the ‘check pattern for photographs’ may be considered as another milestone towards an ideal proportion for facial aesthetics; this is a proof for the fact that in their respective spheres—space to matter and matter to space—all is adjusted in number, weight and measure.

Footnote: on Trichion and FH plane: Trichion, is a Photometric landmark used for the photometric analysis. Tr′ is the code of the landmark Trichion. See FIG. 5 and also see page 258 of Ref 1 cited below. Trichion is the point on the hairline in the midline of the forehead. FH plane: (Frankfurt Horizontal): is a reference plane used in orthodontic cephalometry. See Ref 1 cited below.

Ref 1: Athanasiou, Athanasios E (1995). Orthodontic Cephalometry. London, England:Geoff Greenwood.

‘CHECK PATTERN FOR FRONTAL VIEW PHOTOGRAPHS’ FOR SYMMETRY INDEX: Measurements are made on the frontal view photograph, on the right and left sides from the midline; along or on lines parallel to, the interpupillary line; and values entered in the symmetry calculator, and marks are read as the output.

An illustration of the symmetry calculator is shown in the table in FIG. 6.

Detailed procedure for symmetry analysis is given below.

In FIG. 1, a line is drawn, through midway of the inner canthi of the eye, perpendicular to the inter-pupillary line. This line is shown in blue in FIG. 7. Horizontal distances are measured on either side from this mid line, along or on lines parallel to, the interpupillary line. Measurements are made on the right and left sides, (using the ImageJ), values entered in the symmetry calculator, and symmetry index is readout. For this, ratios are computed between the readings of the right hand side (RHS) and left hand side (LHS); as the ratio of greater measure/lesser measure. For symmetry, the ratio between the readings of the right and left sides should be 1:1.

‘CHECK PATTERN ON PROFILE VIEW PHOTOGRAPHS’ FOR Z INDEX: Procedure for Z analysis: The values of the angles in the Z Analysis are found out. And it is entered in the Z index calculator. Marks are read out.

Z index calculator: An illustration of the z calculator is shown in the table in FIG. 8.

Procedure for Z analysis in the Z calculator: The values of the angles in the Z Analysis are found out. Absolute value of the deviation, of the observed value from the ideal measurement is calculated. Marks are calculated for each parameter in the analysis. The maximum marks for one parameter is 100. Maximum marks for 24 parameters=2400. Sum up the total marks for the 24 parameters, for the candidate, this is the marks scored. Z index=(marks scored/maximum marks)×100=(marks scored/2400)×100. See tables in FIG. 9. Parameters for calculator file on ‘Z index’ and an illustration of total mark calculation for a candidate with ideal values is shown in the table in FIG. 9.

Figures of ‘z angles’ used in the ‘check pattern on profile view photographs’ for z index are presented in FIG. 10 through 21.

‘CHECK PATTERN FOR INDICES FOR FRONTAL AND PROFILE VIEW PHOTOGRAPHS’: The indices for aesthetics: The method for using indices for measuring and grading facial aesthetics from frontal and profile view photographs by giving marks was successfully attempted using the ‘Percentage and Range calculator’ and is presented here.

Procedure: Measurements of the subject are computed; calculate the ratio using ‘index calculator’, from the measurements made on photograph. The tables relating to the ‘check pattern for indices for frontal and profile view photographs’ are available (see reference to the doctoral work in paragraph 0043). Select values from these tables and enter into the appropriate boxes of the ‘Percentage and Range calculator’, and marks appear in the spread sheet. Marks are given as the output in the ‘Percentage and Range calculator’. Find out the marks for the ratio calculated for the subject, from the output in the ‘Percentage and Range calculator’. Using the calculator devised, the marks for a candidate, for a given variable, can be readout.

An illustration of the Index calculator is shown in the table in FIG. 22.

A section from an illustration of the Percentage and Range calculator is shown in the table in FIG. 23.

‘CHECK PATTERN FOR CEPHALOGRAMS’: Procedure: For cephalometric analysis, the cephalograms are manually traced and scanned in the Bitmap (BMP) format to reduce compression. Lines are drawn and measurements are taken using ImageJ. The tables relating to the cephalogram measurements for ‘check pattern for cephalograms’ are available (see reference to the doctoral work in paragraph 0043). Measure the parameters needed from the cephalogram tracing. Locate the name of the parameter from the tables. Enter the parameters available in the tables in the respective columns of the ‘Percentage and Range calculator’, and marks appear as output. From this output, find out the marks of the candidate. Using the ‘Percentage and Range calculator’ devised, the marks of the candidate can be readout, for a known parameter.

For the most common clinically used cephalometric parameters, table for the aesthetically superior group (ASG) are also available (see reference to the doctoral work in paragraph 0043). Marks can be computed for the study group and for the ASG.

‘check pattern for cephalic Index on cephalometric parameters’: Procedure: Measure the Cephalic Index (CI) of the subject and see if it is in the brachycephalic, mesocephalic or dolicocephalic group. Cephalometric measurements are taken for each cephalogram included in aesthetic grading. Compute marks based on the Cephalic Index. Tables relating to the cephalogram measurements for ‘check pattern for CI on cephalometric parameters’ are available (see reference to the doctoral work in paragraph 0043). Locate the name of the parameter and cephalic type from the tables. Enter the values available in the tables in the respective columns of the ‘Percentage and Range calculator’, and marks appear as output. From this, output, find out the marks of the candidate, noted against the measurement obtained for the candidate.

‘Check pattern on anthropometric measurements’: Height, Weight, cephalic Index (C.I), Nasal Index (N.I), Facial Index (F.I.) and so forth are of great importance in determining aesthetic standards. Anthropometric measurements of the candidate are made. For Anthropometric measurements, Standard anthropometric instruments are to be used; standardized textual procedures are to be adhered to (Hooton, Earnest Albert, 1963). The height and weight measurements are used to compute the BMI and the Weight/Height ratio of the candidate, to be used in Check pattern on frontal view photographs. Cephalic measurements are used in the ‘check pattern for cephalic Index on cephalometric parameters’. Details on anthropometric data are available (see reference to the doctoral work in paragraph 0043).

The doctoral work: Details are in my PhD thesis titled “Soft tissue and skeletal parameters for aesthetically attractive young adults of Kerala population”. PhD was awarded in 2010—University of Kerala—Research Center at Government Medical College, Thiruvananthapuram, Kerala, India. The thesis can be produced upon request.

‘Biometrics in facial aesthetics’ is a new contribution made possible through the successfully attempted reproducible quantification methods. The method in ‘Biometrics in facial aesthetics’ is to measure facial AESTHETICS from the standardized diagnostic aids; facial beauty is made a quantitative reproducible measurement by the ‘check pattern’ for ‘Biometrics in facial aesthetics’.

Biometrics of the eye in ‘Biometrics in facial aesthetics’: The unique, universal and permanent measurable features of the eye ensures a software system for ‘Biometrics in facial aesthetics’ that can identify an individual by measuring their physical linear and area patterns for the eye, and comparing it to those on record for the full face. It serves as a unique Key for an individual.

A ‘check pattern’ is drawn for eye. See FIG. 24. Eye to face (linear, angular or area) measures of aesthetics are made for biometric standardisation of the individual. A number of aesthetic measurements for Biometrics of the eye in ‘Biometrics in facial aesthetics’ are identified; two from these are noted here: 1. It is seen from FIG. 25, that the numerals 18 and 45, which are multiples of 3, are found to be in the angular measurements in the eye to face measures of aesthetics for ‘Biometrics in facial aesthetics’. 2. The ratio of areas of the portions outside the arrow but inside the ‘check pattern’ of the eye, shaded in pink, in FIG. 25 is measured to be 1:1.5 for aesthetics for ‘Biometrics in facial aesthetics’. See FIG. 25.

‘Biometrics in facial aesthetics’—A Facial Identification Technology: ‘This refers to identifying an individual aesthetically by measuring their physical uniqueness and patterns, in lines and polygons and circles, through linear, angular and area measurements, and the proportions and ratios of measurements are also calculated; and comparing it to the values available for the face in the records in the check pattern. Identify the polygons on the face and verify the individual by that.

The among the various regular polygons attempted in the check pattern for ‘Biometrics in facial aesthetics’, the triangle, nonagram, regular octagon; hexagram (the star polygon), pentagram, and the Star Figure need special mention. Aesthetic calculation in Tessellation also serves as a Key in ‘Biometrics in facial aesthetics’.

The following are some of the patterns successfully attempted in the check pattern, for ‘Biometrics in facial aesthetics’, using the polygons and lines and ellipses or circles. A few examples are presented in FIG. 26 and FIG. 27. Symmetry is also attempted in detail in ‘Biometrics in facial aesthetics’.

Patterns in ‘check pattern’ analysis, with Analysis named under the following headings were developed for ‘Biometrics in facial aesthetics’: star analysis, cycle graph for the aesthetic biometrics, Obsessed with beauty (for mirror symmetry), SVG, Nonagram, Ladder, stone, door, central hexagon, The twelve of aesthetics, The three Xs of the CP, The Long Zs of the face, Pillars 3 4 5 6 7, Hp on pillar 7, The crowning glory of creation, Crowns, Crown 2 and Crown 3, Central measures, knowledge, Open arrow head test, Golden reed analysis (angles of the golden reed ‘z’ are 54), the golden reed golden triangle, the door base, door foundations, door gates, ribbon bows analysis, GRA 2 BR6, the door, seven seals analysis, crowns to conquer on face, The seven seals, crown to conquer, Crown to conquer on face, seven step analysis, The series of 3-6-9-12 of the ‘crown to conquer on face, Clock analysis, The clock z of the face, The clock analysis-Aesthetic analysis round the clock, 6-3:9-12 length analysis, quadrant analysis, wipe away all tears analysis, the miss perfect nutrition index, QR measures, Feeding analysis, The white robe analysis, Point analysis, The 3-9 to 6-12 length analysis, Wheels of aesthetics, crown from the east for aesthetics, Living foundations, 4 corners analysis, The triangle of beauty, The lengthy hexagons of the face, The perfect hexagon, the perfect star, The perfect star in the miss perfect, Perfect star analysis, Perfect star placement, Bottle, 4 winds, the 4 point star, 5 point star, and the 6 point star; the Ls of face, the Ms of face, the Ls of face, Test of Majors that Includes The major Zs of the face, The major stars of the face and The major omegas of the face; a crown in white, The red crown and the Bow tests, Bow tests in aesthetics, The strong pillar of the face, Ribbon test for aesthetics, Alpha symmetry analysis: Indication of symmetry, Gallery star-hexagons, star hexagons, white basics, caternary curves in the CP, hexagon and hexagon star flower, Measures of symmetry as a whole (area measure), 4 sided to octagon relations, hexagon ratio to triangles, hexagon to hexagon ratios, hexagon to octagon ratios, 4 sided fig to 4 sided figure ratios and angles, hexagon to triangles, hexagon to open and closed arrowheads, The 7 star analysis, The joy lines, The major z of the face, The major z of the face Triangle, Hour glass analysis, Omega analysis, Parallelogram analysis, The diamonds, The static line of the face, The Marching Soldiers, Properties of the marching soldiers, The 4 Z s of the static line, The seven golden lights, The flame theory, The arrows of the face, Shoot the arrows test for CP, Pillars and the arrow, Pillar 1, White triangles, Green triangle, pillar 2 golden monuments, Pillar 2, pillars and the flame of the golden light.

1. What I claim as my invention is that “techniques have been developed to measure and/or quantify beauty for facial aesthetic grading”; frontal and profile view facial photographs, cephalograms and anthropometric measurements are the aids in aesthetic grading; using the ‘check pattern on frontal view facial photographs’ for Beauty Index, and Symmetry; ‘check pattern on profile view facial photographs’ that provides THE FACIAL KEYS TO AESTHETICS, for Z index; ‘check pattern on frontal and profile view facial photographs’ for facial Indices; ‘check pattern on cephalograms’ and ‘Check pattern on anthropometric measurements’, for measurement and/or quantification of facial aesthetics; to get an output for facial aesthetic grading in marks out of 100, which any person can understand; also, techniques for ‘Biometrics in facial aesthetics’ and Biometrics of the eye in ‘Biometrics in facial aesthetics’ have been developed.
